(19) United States
(12) Patent Application Publication
(10) Pub. No.: US 2021/0142694 A1
(43) Pub. Date: May 13, 2021

(54) SYSTEM AND METHOD FOR TEACHING BRAILLE LITERACY

(71) Applicant: ObjectiveEd, Inc., Wellington, FL (US)

(72) Inventors: Martin Schultz, Miami Beach, FL (US); Luke Voelk, Harvard, MA (US)

(21) Appl. No.: 17/094,764

(22) Filed: Nov. 10, 2020

Related U.S. Application Data
(60) Provisional application No. 62/933,607, filed on Nov. 11, 2019.

(51) Int. Cl. G09B 21/00; G06F 16/22

(52) U.S. Cl. CPC G09B 21/007; G06F 16/22

(57) ABSTRACT

A system for providing a feedback loop to teach braille literacy includes a device having information stored thereon corresponding to at least one braille character formed thereon. A reader communicates with the device and reads the information corresponding to the at least one braille character. A computing device communicates with the reader to receive the read information and determines the at least one braille character from the read information. The computing device communicates with a speaker causing the speaker to broadcast the at least one braille character corresponding to the information read by the reader.

### CROSS REFERENCE TO RELATED APPLICATIONS

This application claims the benefit of U.S. Provisional Application No. 62/933,607 filed on Nov. 11, 2019. The entire contents of this application is incorporated herein by reference in its entirety.

### FIELD OF INVENTION

The invention disclosed herein relates generally to a system and method for teaching braille literacy, and more specifically to a system for teaching braille literacy with minimal teacher intervention in a game like feedback environment.

### BACKGROUND OF THE INVENTION

Several studies show that braille literacy is directly correlated with academic achievement and employment among the blind and visually impaired. This is true even when compared with blind and visually impaired individuals who rely on voice synthesizers. As is currently performed, braille literacy is achieved by one to one interaction between the teacher and student. The student first learns each individual letter and then practices reading words on paper which is embossed with braille letters as known in the art. It is the teacher's responsibility to check to see if the student has read each braille word correctly by real time monitoring the student and interacting with the student. The teacher corrects the student when wrong and rewards the student when correct, and is there to help the student when challenged or confused.

This prior art method of teaching has been satisfactory for decades, but it still suffers from the disadvantage that each student requires constant monitoring and interaction with the teacher; limiting the number of students which can be taught at any one time and keeping the teacher from performing other educational activities related to the class.

Accordingly a system which overcomes the shortcomings of the prior art by removing the need for constant individualized teacher time is desired.

### SUMMARY OF THE INVENTION

A system for providing a feedback loop to teach braille literacy includes a device having information stored thereon corresponding to at least one braille character formed thereon. A reader communicates with the device and reads the information corresponding to the at least one braille character. A computing device communicates with the reader to receive the read information and determines the at least one braille character from the read information. The computing device communicates with a speaker causing the speaker to broadcast the at least one braille character corresponding to the information read by the reader.

In one embodiment, a system provides a feedback loop to teach braille literacy and includes a block as the device. A braille character is formed on the block. A near field communication (NFC) tag is disposed on the block. The NFC tag stores a character corresponding to the braille character therein. An NFC tag reader reads the character stored in the NFC tag. A computing device communicates with the NFC tag reader and receives the read character. A speaker communicates with the computing device; the computing device causes the speaker to broadcast the character read by the NFC tag reader.

In another embodiment of the invention, the system includes a flexible sheet as the device. Braille characters are formed on the flexible sheet at predetermined positions along the flexible sheet. A pressure sensitive device is the reader and receives the flexible sheet and determines coordinates for a position to which pressure is applied to the flexible sheet. A computing device communicates with the pressure sensitive device and receives the coordinates. In response thereto the computing device determines a braille character on the flexible datasheet corresponding to the coordinates. A speaker communicates with the computing device and the computing device causes the speaker to broadcast the character corresponding to the coordinates.

### BRIEF DESCRIPTION OF THE DRAWINGS

The present disclosure is better understood by reading the written description with reference to the accompanying drawings and figures in which like reference numerals denote similar structure and refer to the elements throughout, in which:

FIG. 1 is a schematic diagram of a system for learning braille characters in accordance with the invention;

FIG. 2 is an exploded view of a braille character block for learning a character in accordance with the invention;

FIG. 3 is a perspective view of a character block and character block reader in accordance with the invention;

FIG. 4 is a perspective view of a character block and character block reader constructed in accordance with a another embodiment of the invention;

FIG. 5 is a schematic view of a system for learning braille constructed in accordance with another embodiment of the invention;

FIG. 6 is a perspective view of a system for learning braille constructed in accordance with the embodiment of FIG. 5; and

FIG. 7 is a table of values corresponding to a braille sheet as stored in accordance with one embodiment of the invention.

### DETAILED DESCRIPTION OF THE PREFERRED EMBODIMENTS

The subject matter of aspects of embodiments of the present invention is described with specificity herein to meet statutory requirements. However, the description itself is not intended to limit the scope of any patent issuing from this description. Rather, the inventor has contemplated that the claimed subject matter might also be embodied in other ways, to include different elements or combinations of elements similar to the ones described in this document, in conjunction with other present or future technologies.

Reference is made to FIG. 1 in which a system, generally indicated as 110, for teaching braille in accordance with the invention is provided. System 110 includes a block 102 which communicates with a reader 103 to indicate to reader 103 information provided on block 102. Reader 103 communicates with a computing device 104 which operates as a function of the information read by reader 103 to communicate the information on block 102 to a student 105.

In a preferred nonlimiting embodiment, block 102 is a near field communication device and reader 103 is a near field communication reader. As seen in FIG. 2 in a preferred embodiment, block 102 is formed from a block 100 made from wood, plastic or the like and a near field communication (NFC) tag 101 is formed thereon or integrally therewith. A braille character 304 is formed on one face of block 100. An NFC tag 101 is programmed with the identity of a character corresponding to braille character 304 provided on a face of block 102. In the preferred nonlimiting embodiment, tag 101 is a passive device read by reader 103 which is an NFC tag reader. NFC tag reader 103 reads the value, character, stored in NFC tag 101.

As seen in FIG. 3 block 102 has a braille character 304 on at least one side thereof. To aid a sighted person working with a student 105, and to help a blind person visualize and remember each letter, block 102 may also have an indicator, a sighted text version, 302 of the character corresponding to braille character 304 etched into the side of block 102 adjacent the brail character 304; in this example the letter “b”. If NFC tag 101 is placed on an opposed side of block 100 then other sides such as side 306 and/or 308 may be used for other characters. By way of example, at side 306 the symbol for a capital “B” is provided while at side 308 a different braille character 304, corresponding to capital B is provided. The corresponding NFC tag 101 would be disposed on the opposed side of block 100 from sides 306, 308 respectively; enabling up to three characters for each block 102.

NFC tag reader 103 and computing device 104 may be hardwired to communicate with each other or may communicate wirelessly with each other utilizing Bluetooth or other wireless communication protocol. In a further preferred, nonlimiting, embodiment computing device 104 and NFC tag reader 103 may be formed as a unitary device 403 as shown in FIG. 4. In this embodiment, an iPad® or other portable smart device having NFC tag reading capability may be utilized.

Additionally, as seen in FIG. 4, a block 102′, when formed as plastic, may be reduced in size and dimension, and while NFC tag 101 (not shown) may be affixed to the opposed side of block 102 from character 304, in this embodiment the letter “T” and read by NFC reader 403. The NFC tag 101 may alternatively be embedded within block 102′ during the manufacturing process. Such embedded NFC tag 101 provides the benefit that characters 302, 304 may be formed on each of the opposed sides of the embodiment of block 102.

During use, block 102 is placed on NFC tag reader 103 with the NFC tag 101 facing towards NFC tag reader 103. Because NFC tag 101 is disposed on an opposed side from braille character 304, the braille character 304 faces student 105 when properly placed on NFC tag reader 103. When properly placed, NFC tag reader 103 reads the value, character, stored in NFC tag 101 and transmits the character, the letter “b”, to computing device 104. Computing device 104 converts the contents of the NFC tag 101 to an audio signal and broadcasts, in spoken word form, through a speaker 106 associated with computing device 104, the information corresponding to the character stored in NFC block 102; it speaks the letter “b”. It identifies the character on block 102 for the student 105. In this way, feedback is provided to student 105 to confirm or teach the identity of braille character 304 disposed on block 102.

As is known in the art, computing device 104 can be loaded with applications enabling student 105 to interact with computing device 104 by utilizing blocks 102 in a variety of ways. In addition, to the reaffirmation of letters discussed above, a game may be based on questions propagated by computing device 104 to student 105. These questions may prompt a student 105 by requiring that student 105 answer the questions by placing one or more correct blocks 102 on NFC tag reader 103. The character on block 102 may represent a letter, number, punctuation or word.

As computing device 104 knows the question, it also knows the anticipated correct answer. Computing device 104 compares the value read from NFC tag 101 of selected block 102 and compares the value to the anticipated correct value known to computing device 104. If the block 102 selected by student 105 is incorrect, not the known or predetermined block, computing device 104 will broadcast a sound indicating to student 105 that the incorrect block 102 was chosen and may prompt student 105 to try again; or utilize a second question to confirm the same knowledge of blocks 102. If the correct block 102 is chosen, the computing device 104 would provide an indication that the correct block 102 was selected and move onto another skill set.

One embodiment of such an application would be computing device 104 indicating to student 105 that it must select a specific letter to complete a word. Rather than speak the letter, by way of example, the prompt may be “at” in which selecting a block 102 corresponding to “B”, “C”, or “M” would generate a confirmation indication such as speaking the completed word; Bat, Cat, or Mat. However, selection of block 102 corresponding to “Q” would prompt an incorrect answer indicator such as a buzzer. Additionally computing device may store two or more selected characters and announce the characters as a word or phrase.

It follows that if computing device 104 can determine a right answer from a wrong answer; it can keep track of and score the interaction of student 105 with the game application. It can provide a report both locally at computing device 104, or transmit the score to the teacher, at a remote location, who no longer needs to be consistently present for all of the reasons discussed above.

By utilizing the block and reader system discussed above, a student can practice and improve their initial braille literacy without constant supervision by a teacher. This accelerates the learning process, frees up teachers to deal with other students and other tasks, helps the student to achieve braille literacy, while also promoting a sense of independence. Furthermore, the learning experience is transformed from rote learning from printed cards into a fun interactive game where students are more motivated to learn and learn more quickly.

Reference is now made to FIGS. 5 and 6 in which an embodiment of the invention for teaching more advanced braille literacy is provided. A system, generally indicated as 400 for teaching the ability to read words and phrases includes a pressure sensitive reader 404. Pressure sensitive reader 404 detects which portions of a braille sheet 402 is being read as a result of the pressure applied thereto as will be discussed in detail below. Pressure sensitive detector 404 communicates with a computing device 408. Computing device 408 is also in communication with a cloud-based database 406. In a preferred nonlimiting embodiment, pressure sensitive detector 404 and computing device 408 may be formed as a unitary devices, such as a properly programmed iPad® device.

As seen in FIG. 6 sheet 402 is a conventional braille sheet having rows 401a-401n of content. Sheet 401 is flexible sufficient to move in response to the application of pressure at a position of contact with eh sheet. In a preferred nonlimiting example, a first row 401a has the desired characters printed thereon in sighted text. In alternating rows, such as row 40b, the braille equivalent is printed in each row below the corresponding indicated sighted text. By way of example in row 401a the sighted character “a” 403 is presented and in adjacent row 401b the braille character 405 corresponding to “a”, a single raised dot in the left corner of a braille matrix, is presented. Each location along each row 401 has a known coordinate (X,Y) position on sheet 402. Each sheet 402 has an indication number 420 in braille and in sighted text that is an identifying number to indicate the sheet being used. Each identifying number 420 corresponds to a different sheet 402, each sheet 402 having a different pattern of braille and sighted text. It is well within the scope of the invention for sheet 402 to constitute entirely braille characters; no sighted characters.

As seen in FIG. 5 system 400 includes structure for interacting with sheet 402. A pressure sensitive device 404 receives sheet 402 thereupon. Pressure sensitive device 404 determines a position on pressure sensitive device 404 at which pressure, such as a finger push from a student 410 occurs. Pressure sensitive device 404 communicates with a computing device 408; communicating the sensed position as a sensed coordinate (X,Y) position to computing device 408.

Computing device 408 also communicates with a cloud based database 406. Cloud based database 406 stores a table, see FIG. 7, of information with regard to each sheet 402. At a minimum, the information includes the indication number 420. Cloud based database 406 also stores the coordinate position (Xₘ,Yₙ) of each braille character, and the corresponding sighted text character located there, for the braille 405 and sighted characters 403 for each position on the respective sheet 402 associated with identification number 420.

As seen in FIG. 7 a table corresponding to positions on sheet 402, arranged as a grid of X,Y coordinates in which the rows 401ₙ are stored as Y₁-Y₁₀ and the columns are stored as X₁-X₁₀. Following this example, the letter “a”, character 403 on sheet 420, is indicated to be found in sighted version at position X₁, Y1. The corresponding braille character 405 is stored as being at position X₁, Y₂; the position in a row directly beneath the sighted letter. The indicating information 420 is stored, by way of nonlimiting example at known position X₁₁, Y₁. the value stored for sheet 420 at those coordinates is “a” text and braille respectively. The sensed coordinate at pressure sensitive device is sent to computing device 408 for processing as a function of the sensed position and identified sheet.

As a result, computing device 406 utilizes the sensed grid position and identification number 420 for sheet 402 to determine which character corresponds to the determined position by knowing the X,Y coordinate as sensed and comparing it to the value for the sensed coordinate as stored in database 406. If words and phrases are to be stored at particular coordinates, or a series of coordinates, then the starting and ending coordinates of the desired phrase may also be stored in the table to be used by computing device 408 to provide feedback to student 410 as discussed below.

During use, a flexible braille sheet 402 is placed on pressure sensitive device 404. The student or a teacher inputs the identification number 420 into computing device 408 either directly or through pressure sensitive device 404. When student 410 uses their finger to read a braille letter, word fragment, or word their finger puts pressure on sheet 402. This in turn puts pressure on pressure sensitive device 404 at the coordinate of the selected position. Pressure sensitive device 404 determines the position, the corresponding X, Y coordinates, where finger pressure occurred. Pressure sensitive device 404 transmits the position information to computing device 408.

Computing device 408 receives the sensed X, Y coordinates from pressure sensitive device 404 and matches the identified coordinates to the table stored, stored for the identified sheet, in cloud based database 406. Again, computing device 408 is provided with a speaker 412 which speaks the identified letter, word fragment or word corresponding to the coordinates of the student's finger as read-out from the selected table stored in cloud based database 406. This again provides the confirmatory feedback between sensed braille letters and what the letters audibly correspond to. At the same time, computing device 408 may track the pressure responses of student 410 at pressure sensitive device 406.

As with the first embodiment, it is well within the scope of the art to combine pressure sensitive device 404, computing device 408 and, even database 406, as seen in FIG. 6, into a single unitary device. Additionally, while the above embodiment utilizes system 400 in its simplest form, games may again be created that require student 410 to answer questions prompted by the computing device 408. For example, computing device 408 may output a word through speaker 412 and require student 410 to find the spoken word on the embossed braille sheet 402, or spell the word with the provided letters by scanning the sheet 402 and then double tapping sheet 402 to indicate to pressure sensitive device 404 that a particular character was selected, rather than inspected during scanning. Again, computing device 408, having the anticipated answer, can determine whether a match has occurred corresponding to the correct answer. It provides audio feedback as discussed in connection with the braille blocks above.

Orientation of sheet 402 relative to pressure sensitive device 404 governs what characters correspond to a particular position on the coordinate grid. Therefore, a mechanism may be provided to properly orient braille sheet 402 when placed on the pressure sensitive device. This may be a raised structure in a corner of pressure sensitive device 404, Velcro® strips, or punched holes in braille sheet 402 that are lined up and placed on detents on the pressure sensitive device 404.

It should be noted, that braille sheet 402 exists, to some rudimentary extent, in the prior art. One can convert the prior art sheets to the inventive concept, utilizing inputs at pressure sensor device 404 to create a table stored in database 406 corresponding to coordinates and letters, word fragments, characters and word combinations for pre-existing sheets 402. One such embodiment would be the teacher touching a character while a sheet 402 is on pressure sensitive device 404, speaking the identified character into a microphone associated with computing device 408. Computing device 408 will record the teacher's voice along with the coordinates of the teacher's finger on pressure sensitive device 404 to be stored as a newly created table in database 406. For larger items such as word fragments or words, the teacher would touch the beginning character and ending character, speak the word fragment or phrase and the beginning and ending coordinates along with the audio recording would be stored in database 406. In each of the above examples, text to speech technology may be used rather than relying on inputs from the teacher to create new sheets 402.

As a result of the above described systems a game which is appealingly interactive to the student provides interactive activities to teach and practice braille, store the progress of the skills in a secure cloud, and display a student's progress in a web-based dashboard. As is readily seen, by providing audio conformation the system provides a closed loop confirmation and enforcement tool toe the student. By storing results in the cloud, a distributed education system in which a student is taught a skill utilizing an interactive game; the student is tested; and if the student does not perform well, as determined in a nonbiased manner, the system could teach the skill in a different manner.

The foregoing description is considered as illustrative only of the principles of the invention. Further, since numerous modifications and changes will be readily apparent to those skilled in the art, it is not desired to limit the invention to the exact construction and process shown as described above. Accordingly, all suitable modifications and equivalents may be resorted to falling within the scope of the invention as defined by the claims that follow.

What is claimed is:

1. A system for providing a feedback loop to teach braille literacy comprises:
a device, the device having information stored thereon corresponding to at least one braille character formed thereon;
a reader communicating with the device and reading the information corresponding to the at least one braille character;
a computing device communicating with the reader to receive the read information and determining the at least one braille character from the read information; and
a speaker, the computing device communicating with the speaker causing the speaker to broadcast the at least one braille character corresponding to the information read by the reader.

2. The system for providing a feedback loop to teach braille literacy of claim 1, wherein the device is a block, the at least one braille character being formed on the block, the information being stored in a near field communication tag disposed on the block; and the reader being a near field communication tag reader.

3. The system for providing a feedback loop to teach braille literacy of claim 1, wherein the device is a flexible sheet, the information including one or more braille characters being formed on the flexible sheet at predetermined positions along the flexible sheet; the reader is a pressure sensitive device for receiving the flexible sheet and determining coordinates for a position to which pressure is applied to the flexible sheet; the computing device receives the coordinates from the pressure sensitive device and determines a braille character on the flexible sheet corresponding to the determined coordinates; and the computing device causing the speaker to broadcast the character corresponding to the determined coordinates.

4. A system for providing a feedback loop to teach braille literacy comprises:
a block; at least one braille character formed on the block;
a near field communication tag disposed on the block; the near field communication tag storing a character corresponding to the braille character;
a near field communication tag reader for reading the character stored on the near field communication tag;
a computing device communicating with the near field communication tag reader to receive a read character; and
a speaker, the computing device communicating with the speaker causing the speaker to broadcast the character read by the near field communication tag reader.

5. The system for providing a feedback loop to teach braille literacy of claim 4, further comprising a sighted text character disposed on the block, the text character corresponding to the braille character.

6. The system for providing a feedback loop to teach braille literacy of claim 4, wherein the character is one of a letter, number and word.

7. The system for providing a feedback loop to teach braille literacy of claim 4, further comprising an application stored for operating the computing device, the application causing the computing device to prompt a student to select a predetermined block to be read by the reader, determine whether the selected block is the predetermined block, and causing the computing device to cause a first output at the speaker if the predetermined block is read, and causing a second output at the speaker if a block other than the predetermined block is read.

8. A system for providing a feedback loop to teach braille literacy comprises:
a flexible sheet;
one or more braille characters formed on the flexible sheet at predetermined positions along the flexible sheet;
a pressure sensitive device for receiving the flexible sheet and determining coordinates for a position to which pressure is applied to the flexible sheet;
a computing device receiving the coordinates from the pressure sensitive device and determining a braille character on the flexible sheet corresponding to the determined coordinates; and
a speaker, the computing device communicating with the speaker and causing the speaker to broadcast the character corresponding to the determined coordinates.

9. The system for providing a feedback loop to teach braille of claim 8, further comprising sighted text characters formed on the flexible sheet at predetermined positions adjacent a corresponding braille character.

10. The system for providing a feedback loop to teach braille of claim 8, wherein the character is one of a letter, number and word.

11. The system for providing a feedback loop to teach braille of claim 8, further comprising a database, the computing device communicating with the database, the data base storing information for at least one flexible sheet, the information comprising the coordinate position of each character for each position on the flexible sheet.

12. The system for providing a feedback loop to teach braille of claim 11, further comprising a second flexible sheet, one or more braille characters formed on the second flexible sheet at predetermined positions, in a pattern different than the first flexible sheet, along the second flexible sheet; the data base storing information for the second flexible sheet, the information comprising the coordinate position of each character for each position on the second flexible sheet.

13. The system for providing a feedback loop to teach braille of claim 11, further comprising a respective identification number disposed on each flexible sheet, the identification number identifying each sheet to the computing device; the control number for each flexible sheet being stored in the data base and mapped to the coordinate position of each character for each position on the flexible sheet for which the control number is disposed thereon.
